(19) United States
(12) Patent Application Publication
(10) Pub. No.: US 2018/0221873 A1
(43) Pub. Date: Aug. 9, 2018

(54) MICROFLUID CHANNEL WITH DEVELOPER PORT

(71) Applicant: HEWLETT-PACKARD DEVELOPMENT COMPANY, L.P., Houston, TX (US)

(72) Inventors: JEREMY HARLAN DONALDSON, Corvallis, OR (US); MICHAEL HAGER, Corvallis, OR (US); THOMAS R STRAND, Corvallis, OR (US); ALEXANDER GOVYADINOV, Corvallis, OR (US)

(73) Assignee: Hewlett-Packard Development Company, L.P., Houston, TX (US)

(21) Appl. No.: 15/748,585

(22) PCT Filed: Dec. 14, 2015
(86) PCT No.: PCT/US2015/065604

§ 371 Date: Jan. 29, 2018

(51) Int. Cl. B01L 3/00

(52) U.S. Cl. CPC B01L 3/502707; B01L 3/502723; B01L 3/502715; B01L 2300/0887; B01L 2200/0689; B01L 2300/0883; B01L 2200/0684

(57) ABSTRACT

An example microfluidic device comprises a substrate having a first surface and a cover layer above the first surface. The cover layer and the first surface form a microfluidic channel and a chamber. The example microfluidic device further comprises a functional port in the cover layer over the chamber and at least one developer port in the cover layer over the microfluidic channel. The developer port is above a portion of the microfluidic channel that is not proximate to the functional port.

### BACKGROUND

Microfluidic devices are used in many applications. For example, such devices are used in systems often referred to as “lab-on-a-chip”. These devices may include fluids flowing through narrow channels. In a lab-on-a-chip, for example, blood cells may be moved from one chamber to another, such as from an input port to a reaction chamber.

### BRIEF DESCRIPTION OF THE DRAWINGS

For a more complete understanding of various examples, reference is now made to the following descriptions taken in connection with the accompanying drawings in which:

FIG. 1 illustrates a cross-sectional side view of an example microfluidic device;

FIG. 2 illustrates a cross-sectional side view of another example microfluidic device;

FIG. 3 illustrates a cross-sectional side view of another example microfluidic device;

FIG. 4 illustrates a top view of the example microfluidic device of FIG. 3;

FIG. 5 illustrates a top view of another example microfluidic device;

FIGS. 6-8 illustrate different stages in the formation of an example microfluidic device;

FIGS. 9 and 10 illustrate additional stages in the formation of an example microfluidic device;

FIG. 11 illustrates an example process of using an example microfluidic device; and

FIG. 12 illustrates an example process of making an example microfluidic device.

### DETAILED DESCRIPTION

Various examples described herein include microfluidic devices that may include long and narrow channels with improved removal of filler material, such as wax. The example microfluidic devices include a functional port, such as a nozzle, and at least one developer port. In other examples, the example microfluidic devices may include a micropump, such as a bubble-driven, inertial micropump within the channel. In some examples, the example microfluid devices may not include a functional port but may instead include a channel for flow of fluid from one chamber to either a second chamber or return to the first chamber. The developer port may allow for removal of a filler material (e.g., wax) in a lost wax process in regions of the channels that are not in the area of the functional port. Further, the developer ports may be used for priming of the channels to facilitate flow of a fluid. The use of developer ports for priming may be particularly useful for microfluidic devices with long microfluidic channels with a high length-to-width ratio, for example. In some example, the developer ports may be used for venting of the channels or a chamber. In other examples, the developer ports may be sealed to, for example, prevent evaporation of a fluid.

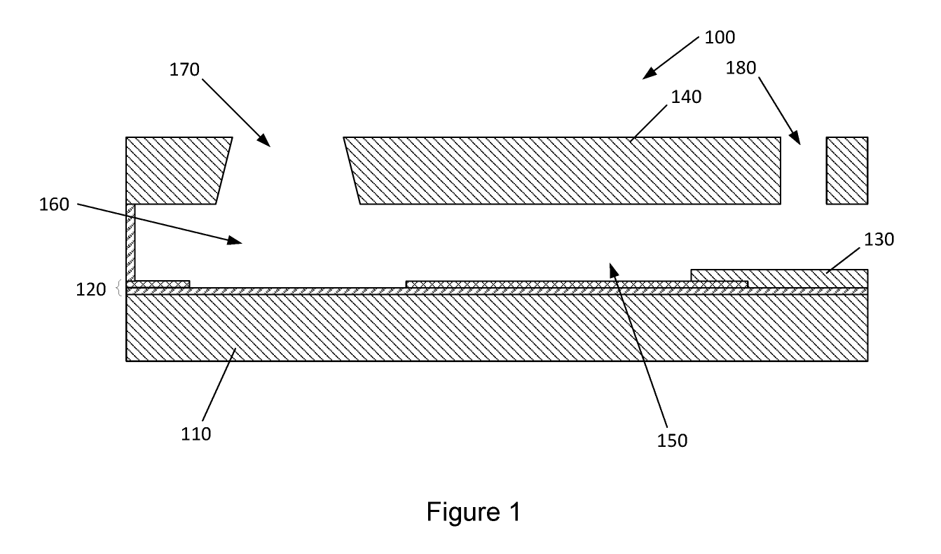

Referring now to FIG. 1, a cross-sectional view of an example microfluidic device is illustrated. The microfluidic device 100 of FIG. 1 may be, for example, a lab-on-a-chip device or a part thereof. It will be understood that, for purposes of simplicity, FIG. 1 illustrates only a portion of the example microfluidic device 100, which may include various other components.

The example microfluidic device 100 includes a stack of layers which may be formed of a variety of materials. The example microfluidic device 100 includes a substrate 110, which may be formed of a silicon material. In various examples, the substrate 110 may be formed of single crystalline silicon, polycrystalline silicon, gallium arsenide, glass, silica, ceramics or any semiconducting material. In one example, the substrate 110 has a thickness between about 500 μm and about 1200 μm. As used herein, “about” may include a value that is within ±10%.

A thin film stack 120 may be formed on one surface of the substrate. In one example, the thin film stack 120 includes at least one thin film layer. For example, the thin film stack 120 may include at least one active layer, an electrically conductive layer, a layer with micro-electronics and/or a capping layer. The various layers may be formed of a variety of materials including the materials described above with reference to the substrate, titanium, titanium alloy or a variety of other materials suitable for that layer. Each layer in the thin film stack 120 may have a thickness appropriate for the purpose and the material of that particular layer. In one example, the layers in the thin film stack 120 have a thickness between about 2 μm and about 100 μm.

The example microfluidic device 100 of FIG. 1 includes a primer layer 130 formed above the thin film stack 120. The primer layer 130 may be formed of a material which facilitates flow of a fluid above the primer layer 130. In this regard, the material for the primer layer 130 may be chosen based on the fluid for which the microfluidic device is designed. For example, if the example microfluidic device 100 is designed for flow of ink, the primer layer 130 may be formed of a material which is resistant to ink. Similarly, if the example microfluidic device 100 is designed as a lab-on-a-chip and may be used for flow of blood cells, the material forming the primer layer 130 may be formed of SU8, an epoxy-based material. In one example, the primer layer 130 has a thickness of between about 2 μm and 100 μm.

The example microfluidic device 100 includes a cover layer 140 at the top of the example microfluidic device 100. The cover layer 140 may be formed of a variety of materials. In one example, the cover layer 140 is formed of SU8, an epoxy-based material. The thickness of the cover layer 140 may be selected based on various desires. For example, the cover layer 140 may be sufficiently thick to shield components within the example microfluidic device 100 from external forces (e.g., electrical or magnetic forces). In one example, the cover layer 140 has a thickness between about 2 μm and 200 μm.

The cover layer 140 and the top surface of the substrate 110 (including the thin film stack 120) form a microfluidic channel 150 therebetween. In various examples, the microfluidic channel 150 is generally a long and/or narrow channel. In various examples, the microfluidic channel has a length of at least about 100 μm. The microfluidic channel may have a width of less than about 20 μm.

The microfluidic channel 150 may communicate a fluid from, for example, a reservoir or an inlet (not shown) to a chamber 160 formed in a portion of the microfluidic channel 150. The chamber 160 may be, for example, a reaction chamber or a firing chamber. In this regard, fluid may be ejected from the chamber 160 through a functional port 170 formed above the chamber. The functional port 170 may be formed as, for example, a firing nozzle. In various examples, the functional port 170 is formed as an opening extending completely through the cover layer 140. In various examples, the functional port 170 may be a circular or conical opening with a diameter between about 1 μm and about 100 μm. Of course, openings of various other shapes are possible and are contemplated within the scope of the present disclosure. For example, various example microfluidic devices may have ports with oval, dog-bone, triangular or other such shapes.

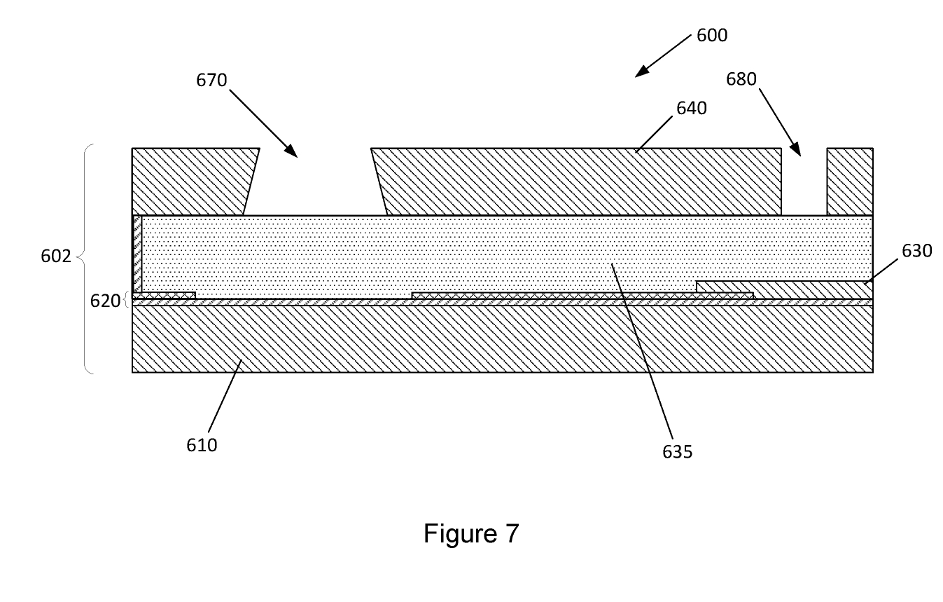

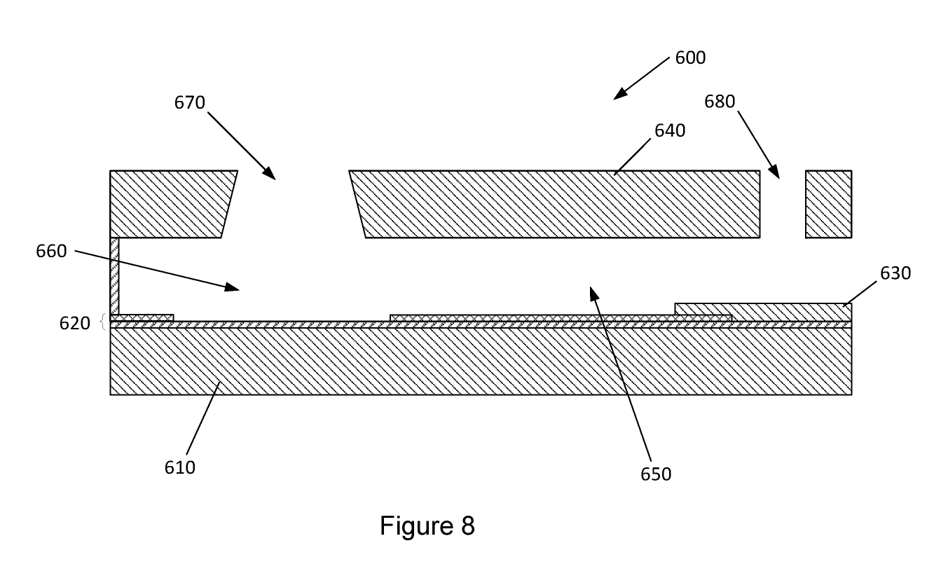

In addition to the functional port 170, the example microfluidic device 100 is provided with at least one developer port 180. Like the functional port 170, the developer port 180 is formed as an opening extending completely through the cover layer 140. In various examples, the developer port 180 may be a circular opening with a diameter between about 4 μm and about 15 μm, between about 2 μm and about 20 μm, between about 1 μm and about 50 μm, or between about 1 μm and about 100 μm. As described below with reference to FIGS. 7 and 8, the developer port 180 may facilitate in the forming of the microfluidic channel 150 of the example microfluidic device 100.

Further, the developer port 180 may be used for venting of the microfluidic channel 150. For example, flowing of a fluid through the microfluidic channel 150 may result in the formation of air bubbles in the fluid. Air bubbles may be undesirable as fluid is ejected from the chamber 160 through the functional port 170. The developer port 180 may allow for the venting of air bubbles from the microfluidic channel 150.

The developer port 180 may also be used for priming of the microfluidic channel 150 in preparation for flowing of a fluid therethrough. In one example, the microfluidic channel 150 may be primed by filling the channel with a fluid, either a priming fluid or the same fluid as the flowing fluid. In the example microfluidic device 100 of FIG. 1, the microfluidic channel 150 may be primed by injecting a fluid through the developer port prior to flowing of the fluid through the microfluidic channel 150.

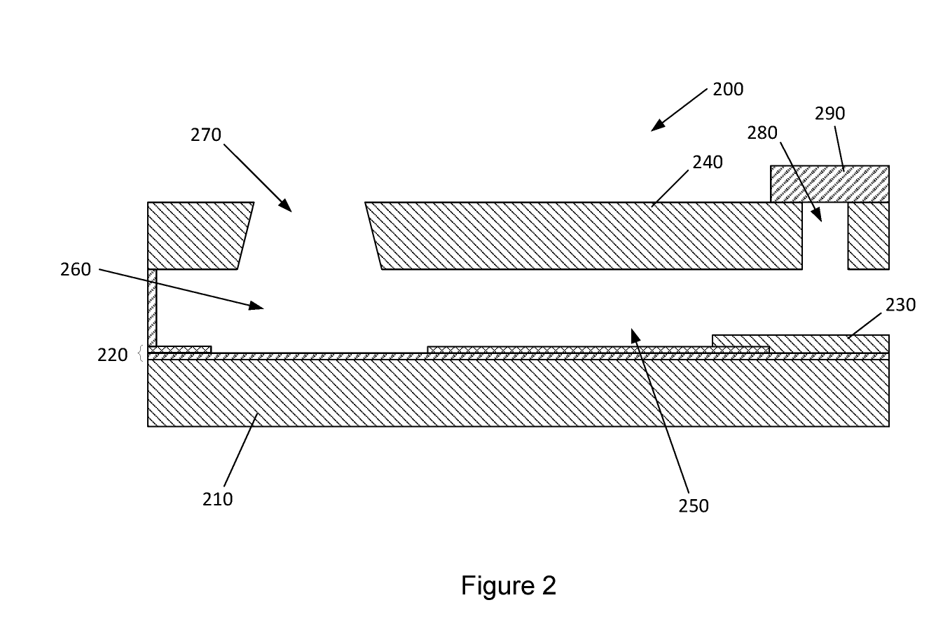

Referring now to FIG. 2, a cross-sectional view of another example microfluidic device is illustrated. The microfluidic device 200 of FIG. 2 is similar to the microfluidic device 100 of FIG. 1 and includes a substrate 210, a thin film stack 220, a primer layer 230, a cover layer 240, a microfluidic channel 250, a chamber 260, a functional port 270 and a developer port 280, each of which is similar to the corresponding feature of the example microfluidic device 100 described above with reference to FIG. 1. In the example microfluidic device 200 of FIG. 2, the developer port 280 is sealed from the atmosphere. In this regard, a sealing layer 290 is formed above the cover layer 240. The sealing layer 290 is formed above the developer port 280 to form a seal. In this regard, the developer port 280 of the microfluidic device 200 may be used for the formation of the microfluidic channel 250. However, the developer port 280 may be sealed to prevent, for example, undesired evaporation of the fluid in the microfluidic channel 250.

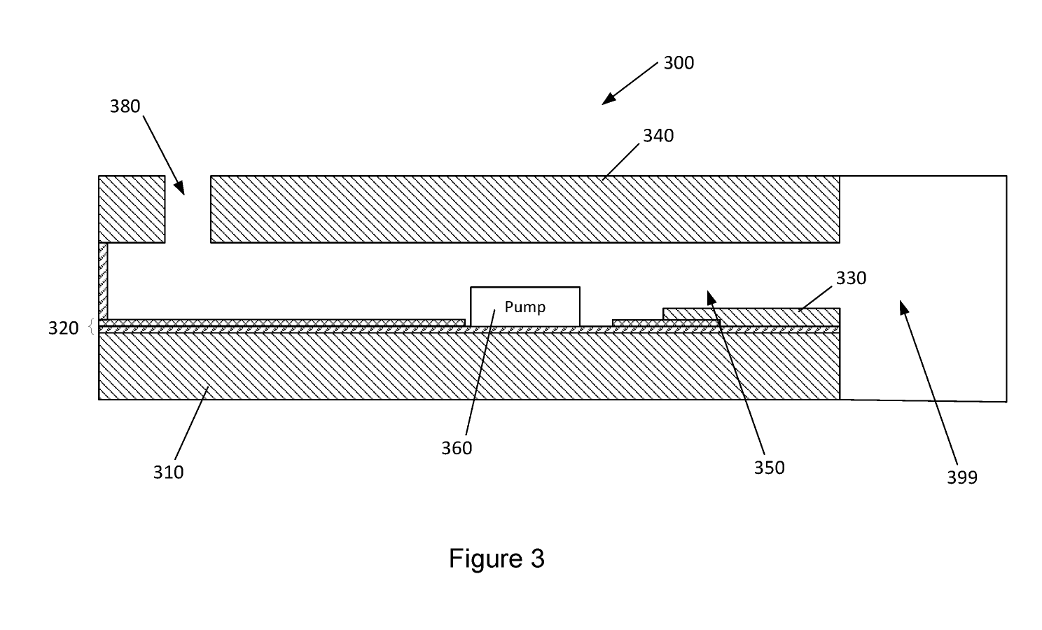

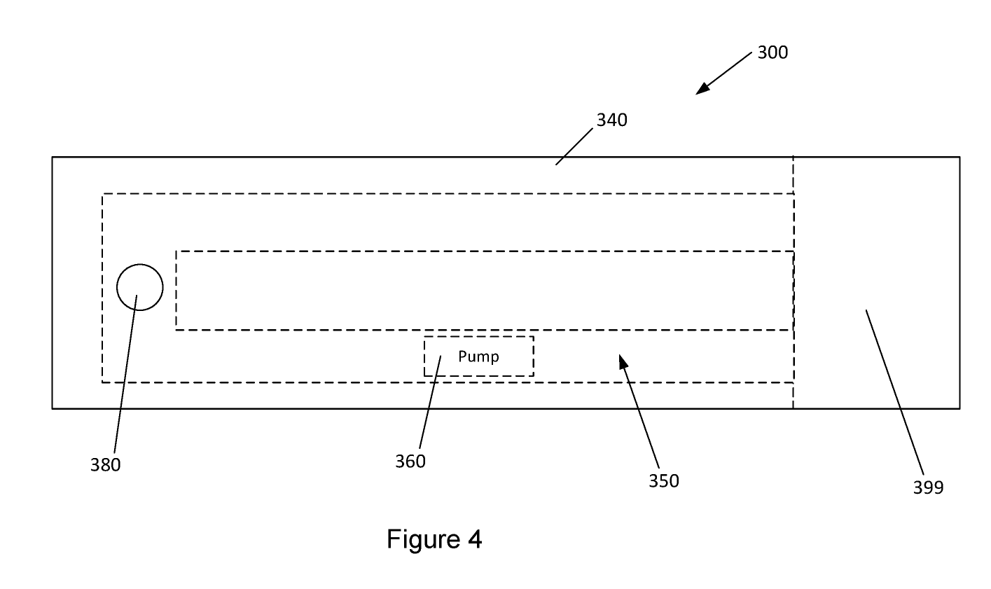

Referring now to FIG. 3, a cross-sectional side view of another example microfluidic device 300 is illustrated. FIG. 4 illustrates a top view of the example microfluidic device 300 of FIG. 3. The microfluidic device 300 of FIG. 3 is similar to the microfluidic device 100 of FIG. 1 and the microfluidic device 200 of FIG. 2 and includes a substrate 310, a thin film stack 320, a primer layer 330, a cover layer 340, a microfluidic channel 350 and a developer port 280, each of which is similar to the corresponding feature of the example microfluidic devices 100, 200 described above with reference to FIGS. 1 and 2. In the example microfluidic device 300 of FIG. 3, the microfluidic channel 350 does not include a chamber, and the cover layer 340 does not contain a functional port. In this regard, the microfluidic channel 350 may be provided to circulate fluid from a chamber, such as the fluid chamber 399, and back to the chamber 399. In this regard, the microfluidic channel may be long, narrow channel, and the developer port 380 may be used to, for example, remove filler material (e.g., wax) from the microfluidic channel during formation of the microfluidic device 300, as described below. Further, the developer port may be used to prime or vent the microfluidic channel 350. In some examples, the developer port 380 may be sealed with a sealing layer, similar to that described above with reference to FIG. 2.

In the example of FIGS. 3 and 4, the microfluidic device 300 is provided with a pump 360 in the microfluidic channel 350. In various examples, the pump 360 may be a microfluidic pump to facilitate flow of fluid through the long, narrow microfluidic channel 350. The pump 360 may be any of a variety of pumps, such as a bubble-driven inertial micropump, for example.

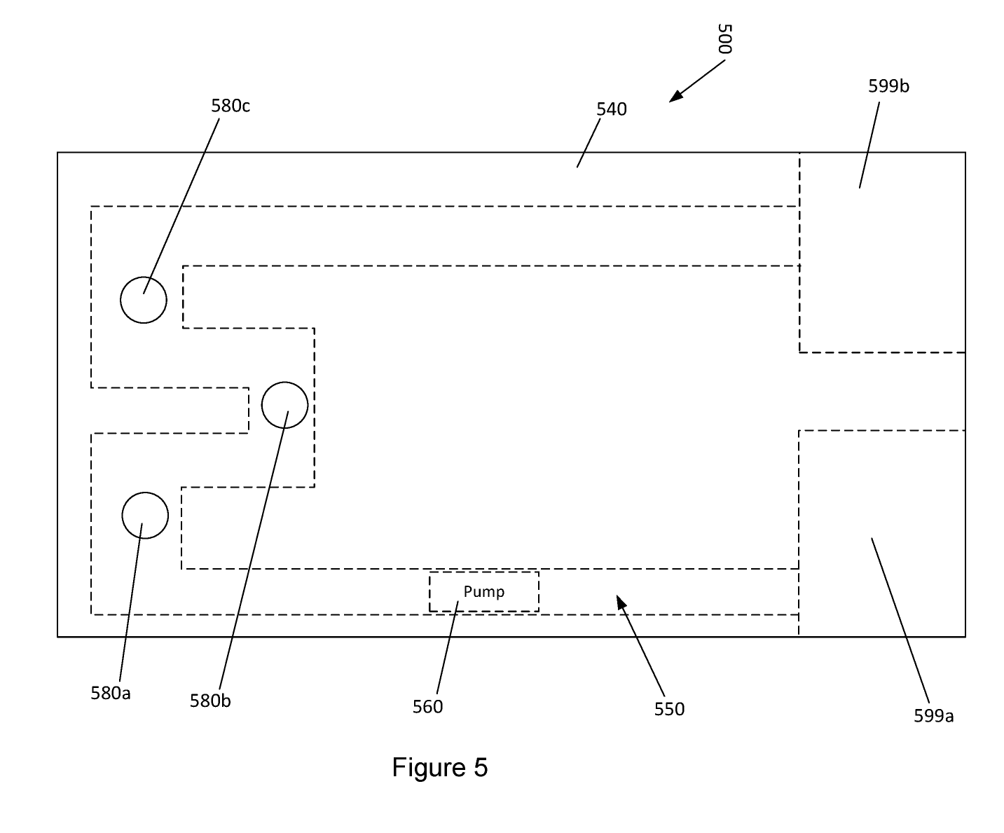

Referring now to FIG. 5, a top view of another example microfluidic device 500 is illustrated. The microfluidic device 500 of FIG. 5 is similar to the microfluidic device 300 of FIGS. 3 and 4 and includes a substrate (not shown), a cover layer 540, a microfluidic channel 550, a pump 560 and at least one developer port 580a-c. in the example microfluidic device 500 of FIG. 5, the microfluidic channel 550 may be provided to circulate fluid from a first chamber, such as the fluid chamber 599a, to a second chamber 599b.

As illustrated in FIG. 5, the microfluidic channel may be a long, narrow channel with a tortuous path. In this regard, the developer ports 580a-c may be positioned to allow more complete removal of filler material (e.g., wax) from the microfluidic channel during formation of the microfluidic device 500, as described below. Further, the developer port may be positioned to prime or vent the microfluidic channel 550 throughout the tortuous path.

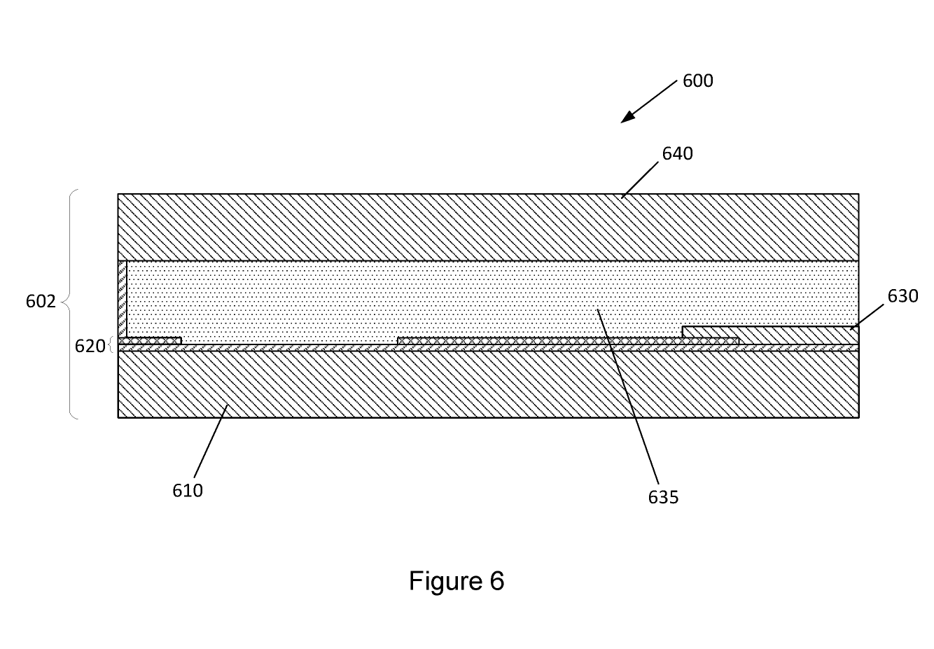

Referring now to FIGS. 6-8, an example formation of an example microfluidic device 600 is illustrated. Referring first to FIG. 6, a stack of layers 602 from which the example microfluidic device is formed is illustrated. The stack of layers 602 may be formed in using methods such as deposition, growth or mechanical formation, details of which are beyond the scope of the present disclosure. The stack of layers 602 includes a substrate 610 which, as described above, may be formed of a silicon material. The substrate 610 may be provided as a base for the formation of the stack of layers 602 and may be formed using any of a variety of mechanical processes, for example. A thin film stack 620 is provided above the substrate 610 and may include at least one thin film layer. The various thin film layers of the thin film stack 620 may be formed, deposited or otherwise positioned above the substrate 610. A primer layer 630 is provided over at least a portion of the thin film stack 620.

A layer of filler material 635 is provided above the thin film stack 620 and the primer layer 630 on one side of the substrate 610. The filler material 635 is provided as a temporary layer which is removed to form a gap or, as described below with reference to FIG. 8, a microfluidic channel. In this regard, the dimensions of the filler material 635 in the stack of layers 602 corresponds to the desired dimensions of the microfluidic channel. In various examples, the filler material 635 is a wax material. A cover layer 640 is formed above the filler material 635.

Referring now to FIG. 7, a functional port 670 and at least one developer port 680 are formed in the cover layer 640. The functional port 670 and the developer port 680 may be formed by a variety of methods. In one example, laser etching may be used to remove material from the cover layer 640. In other examples, material from the cover layer 640 may be removed by methods such as dry etching, wet etching or a variety of other mechanisms. In various examples, a masked pattern may be used to facilitate the removal of material.

Referring now to FIG. 8, the filler material 635 is cleared to form a microfluidic channel 650 and a chamber 660. The filler material 635 may be removed in a variety of manners. For example, in the case where the filler material 635 is a wax material, the filler material 635 may be removed using heat, mechanical removal or the use of a solvent. The solvent may be used to dissolve the filler material, allowing removal along with the solvent.

In the case of microfluidic channels which are long and/or narrow, removal of filler material through a particular port may be limited. For example, removing filler material through only the functional port 670 may effectively remove filler material only up to a limited length of the microfluidic channel 650 or a limited distance away from the functional port 670. The precise distance may be dependent on the width of the microfluidic channel 650. Thus, the example microfluidic device 600 may be provided with the at least one developer port at a position that is not proximate to the functional port 670. In various examples, the developer ports are positioned such that filler material may be removed from the functional port 670 as well as each of the developer ports to allow complete or nearly complete removal of all filler material from the desired microfluidic channel 650. In this regard, the positioning of the developer ports may be a function of the size of the developer port or the size of the microfluidic channel. For example, each developer port may be positioned a distance from either the functional port 670 or another developer port, where the distance is a function of the diameter of the functional port. In one example, the developer port is positioned at a distance from the functional port that is about 10 times the diameter of the developer port.

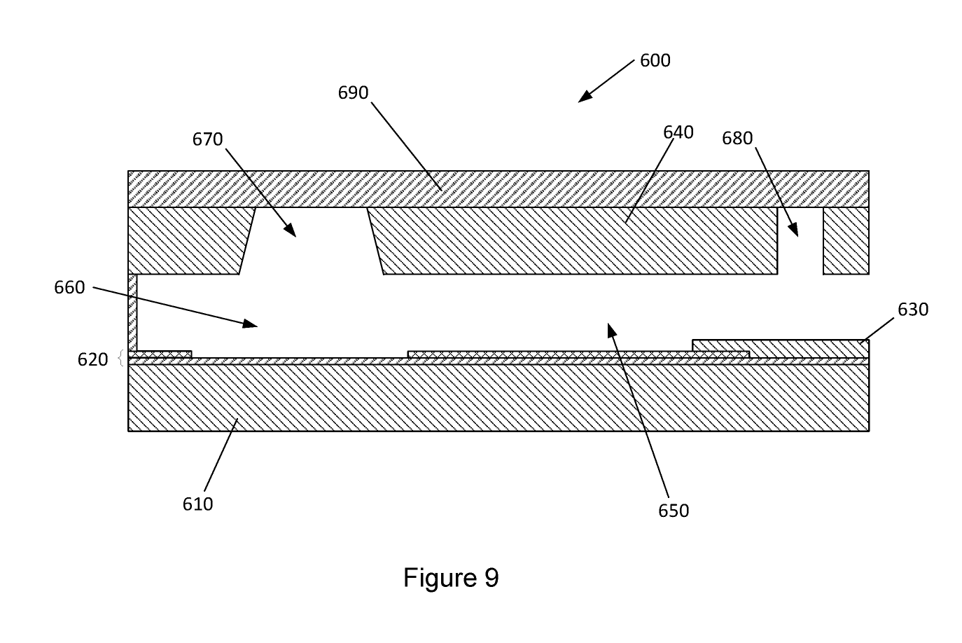

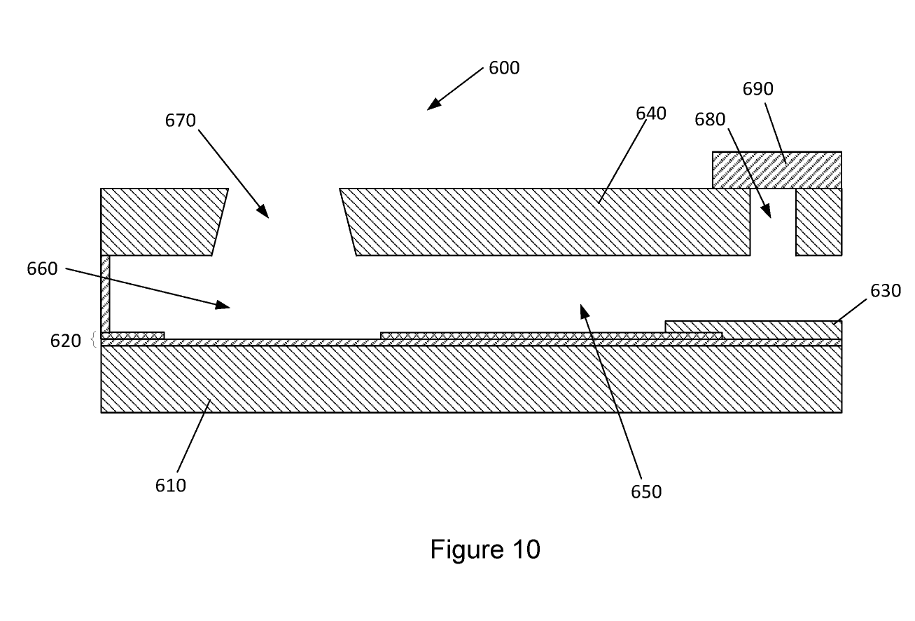

Referring now to FIGS. 9 and 10, an example formation of an example microfluidic device 600 is illustrated. FIGS. 9 and 10 illustrate additional example processes that may be used to seal the developer ports in the example microfluidic device 600. Referring first to FIG. 9, a sealing layer 690 is formed on top of the microfluidic device 600 shown in FIG. 8. The sealing layer 690 may be formed of a dry film lamination. The thickness of the sealing layer 690 is sufficient to provide a seal above the developer port 680. As shown in FIG. 10, the sealing layer is at least partially removed. In one example, the sealing layer is removed to expose at least the functional port 670. In the example illustrated in FIG. 10, the sealing layer is removed from all but above the developer port 680.

In the examples illustrated in the figures above, some example microfluidic devices are illustrated with a single developer port. It will be understood that any number of developer ports are possible and are contemplated within the scope of the present disclosure. For example, as illustrated in the example of FIG. 5, the microfluidic device 500 is provided with three developer ports.

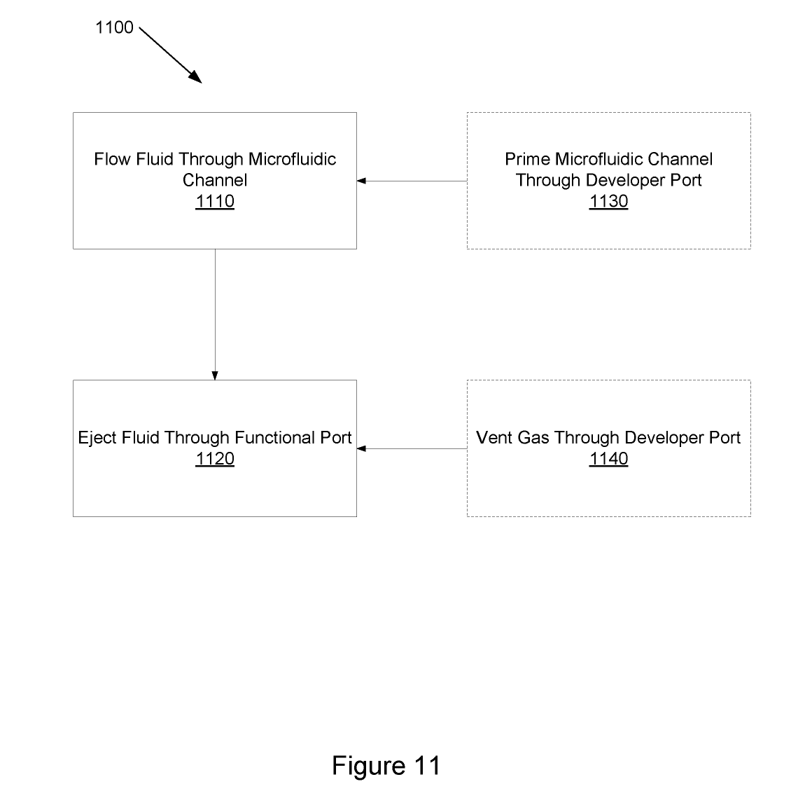

Referring now to FIG. 11, an example process of using an example microfluidic device is illustrated. In accordance with the example process 1100, a fluid is flowed through the microfluidic channel of a microfluidic device, such as the example microfluidic device 100 of FIG. 1 or the example microfluidic device 200 of FIG. 2 (block 1110). The fluid may be flowed from a reservoir or an inlet and through the microfluidic device. The fluid is then ejected through a functional port of the microfluidic device, such as the functional port 170 of the example microfluidic device 100 of FIG. 1 or the functional port 270 of the example microfluidic device 200 of FIG. 2 (block 1120).

In some examples, as described above, the developer port may be used to prime the microfluidic channel. Accordingly, as indicated by the dashed box, in some examples, the process 1100 may include priming the microfluidic channel through the developer port, such as the developer port 180 of the example microfluidic device 100 of FIG. 1 (block 1130).

Further, in some examples, as described above, the developer port may be used for venting. Accordingly, as indicated by the dashed box, in some examples, the process 1100 may include venting a gas (e.g., air bubbles) through the developer port, such as the developer port 180 of the example microfluidic device 100 of FIG. 1 (block 1140).

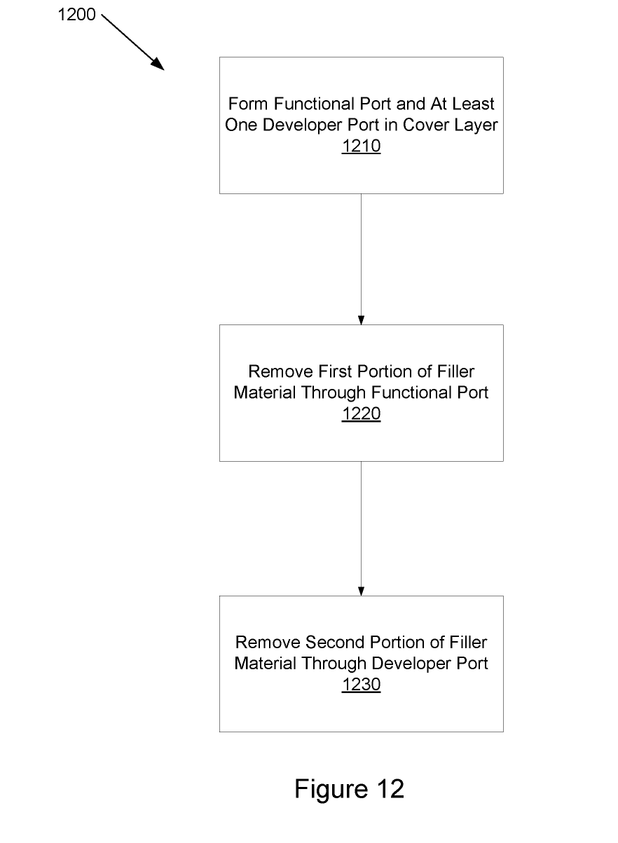

Referring now to FIG. 12, an example process of making an example microfluidic device is illustrated. in the example process 1200, a functional port and at least one developer port may be formed in a cover layer of a microfluidic device (block 1210). For example, as described above, with reference to FIG. 7, the functional port 670 and the developer port 680 may be formed in the cover layer 640 of the example microfluidic device 600. Filler material may then be removed from the microfluidic device to form a microfluidic channel. In this regard, a first portion of the tiller material may be removed through the functional port (block 1220), and a second portion of the filler material may be removed through the developer port (block 1230). In some examples, the removal of the filler material through the functional port and the developer port may be performed simultaneously.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. A microfluidic device, comprising:
a substrate having a first surface;
a cover layer above the first surface, the cover layer and the first surface forming a microfluidic channel and a chamber;
a functional port in the cover layer over the chamber; and
at least one developer port in the cover layer over the microfluidic channel, the developer port being above a portion of the microfluidic channel that is not proximate to the functional port.

2. The microfluidic device of claim 1, wherein the functional port is a firing nozzle to eject a fluid from the chamber.

3. The microfluidic device of claim 1, wherein the at least one developer port is to allow venting from the microfluidic channel.

4. The microfluidic device of claim 1, wherein the microfluidic channel is at least about 100 μm in length or less than about 20 μm in width.

5. The microfluidic device of claim 1, further comprising a sealing layer formed at least above the at least one developer port to prevent venting or evaporation through the at least one developer port.

6. The microfluidic device of claim 5, wherein the sealing layer is formed with a layer of a dry film lamination.

7. The microfluidic device of claim 1, wherein the first surface of the substrate includes:
a thin film layer; and
a primer layer.

8. The microfluidic device of claim 7, wherein the thin film layer is formed of at least one of field oxide, silicon dioxide, aluminum oxide, silicon carbide, silicon nitride and glass.

9. A method, comprising:
flowing fluid through a microfluidic channel of a microfluidic device, the microfluidic device having a functional port and at least one developer port in a cover layer formed above the microfluidic channel; and
ejecting the fluid through the functional port.

10. The method of claim 9, further comprising:
priming the microfluidic channel through the developer port.

11. The method of claim 9, further comprising:
venting a gas from the microfluidic channel through the developer port.

12. A microfluidic device, comprising:
a substrate having a first surface;
a cover layer above the first surface, the cover and the first surface forming a microfluidic channel; and
at least one developer port in the cover layer over the microfluidic channel.

13. The microfluidic device of claim 12, further comprising:
a micropump in the microfluidic channel.

14. The microfluidic device of claim 12, wherein microfluidic channel is to circulate fluid from a chamber and return the fluid to the chamber.

15. The microfluidic device of claim 12, wherein the microfluidic channel is to circulate fluid from a first chamber to a second chamber.
